(19) United States
(12) Patent Application Publication
(10) Pub. No.: US 2010/0281235 A1
(43) Pub. Date: Nov. 4, 2010

(54) RECONFIGURABLE FLOATING-POINT AND BIT-LEVEL DATA PROCESSING UNIT

(76) Inventors: Martin Vorbach, Lingenfeld (DE); Frank May, Munchen (DE); Volker Baumgarte, Munchen (DE)

Correspondence Address: KENYON & KENYON LLP, ONE BROADWAY, NEW YORK, NY, 10004, US

(21) Appl. No.: 12/743,356

(22) PCT Filed: Nov. 17, 2008
(86) PCT No.: PCT/DE2008/001892

§ 371 Date: Jun. 29, 2010

(30) Foreign Application Priority Data
Nov. 17, 2007 (DE) 10 2007 055 131.4
Nov. 23, 2007 (DE) 10 2007 056 806.3
Mar. 18, 2008 (DE) 10 2008 014 705.2

(51) Int. Cl. G06F 15/76; G06F 9/02; G06F 9/302

(52) U.S. Cl. 712/15; 712/E09.002; 712/E09.017

(57) ABSTRACT

Blocks of fixed-point units in a reconfigurable data processing unit assist the efficient calculation of floating decimal point numbers by virtue of joint hardware functions permanently implemented within the block.

### CROSS-REFERENCES TO RELATED APPLICATIONS

This application is the National Stage of International Application No. PCT/DE2008/001892, filed Nov. 17, 2008, which claims priority to German Patent Application No. DE 10 2007 055 131.4, filed Nov. 17, 2007, German Patent Application No. DE 10 2007 056 806.3, filed Nov. 23, 2007, and German Patent Application No. DE 10 2008 014 705.2, filed Mar. 18, 2008, the entire contents of each of which are expressly incorporated herein by reference.

### FIELD OF THE INVENTION

The present invention relates to data processing and in particular but not exclusively to a reconfigurable data processing unit with an expansion for the accelerated processing of floating-point numbers as well as processes for data processing and/or bit data.

### BACKGROUND OF THE INVENTION

Data processing processes and a corresponding optimized, conventional processor.

The term reconfigurable architecture denotes, among other things, modules (VPU) that comprise a plurality of elements changeable in function and/or networking during operation but not exclusively without disturbing other units and/or elements for the run time. The elements may include arithmetic logic units, FPGA ranges, input-output cells, memory cells, analog assemblies, etc. Modules of this type are known, for example, under the designation of VPU. This designation typically comprises arithmetic, logical, analog, memory, and/or networking modules designated as PAEs and arranged one-dimensionally or multidimensionally, and/or communicative peripheral assemblies (IO) that are directly connected to each other or by one or more bus systems. The PAEs may be arranged in any design, mixture and hierarchy, which arrangement is designated as a PAE array or, for short, a PA. A configuring unit may be associated with the PAE array or parts of it. In principle, in addition to VPU modules, even systolic arrays, neural networks, multi-processor systems, processors with several arithmetic units and/or with logical cells, networking modules and backbone network modules such as a crossbar circuit, etc. are known as well as FPGAs, DPGAs, transputers, etc.

### BRIEF SUMMARY OF THE INVENTION

The exemplary embodiments in accordance with the present invention, for example, the described floating-point arrangements, may be readily integrated, e.g., in Xilinx modules of the more recent Virtex family and/or in other FPGAs, DSPs, or processors.

Aspects of the VPU technology are described in the following applications of the same applicant as well as in the associated subsequent applications of the cited applications:

P 44 16 881.0-53, German Patent Application No. DE 197 81 412.3, German Patent Application No. DE 197 81 483.2, German Patent Application No. DE 196 54 846.2-53, German Patent Application No. DE 196 54 593.5-53, German Patent Application No. DE 197 04 044.6-53, German Patent Application No. DE 198 80 129.7, German Patent Application No. DE 198 61 088.2-53, German Patent Application No. DE 199 80 312.9, International Patent Application No. PCT/DE00/01869, German Patent Application No. DE 100 36 627.9-33, German Patent Application No. DE 100 28 397.7, German Patent Application No. DE 101 10 530.4, German Patent Application No. DE 101 11 014.6, International Patent Application No. PCT/EP00/10516, European Patent Application No. EP 01 102 674.7, German Patent Application No. DE 102 06 856.9, U.S. Provisional Application Ser. No. 60/317,876, German Patent Application No. DE 102 02 044.2, German Patent Application No. DE 101 29 237.6-53, German Patent Application No. DE 101 39 170.6, International Patent Application No. PCT/EP03/09957, International Patent Application No. PCT/EP2004/006547, European Patent Application No. EP 03 015 015.5, International Patent Application No. PCT/EP2004/009640, International Patent Application No. PCT/EP2004/003603, European Patent Application No. EP 04 013 557.6, PACT62, and PACT68.

It is pointed out that the previously cited documents are incorporated for purposes of disclosure in particular as regards particularities and details of networking, configuration, the design of architectural elements, trigger processes, etc. without being limiting in the present instance, for example, as concerns definitions and the like contained in them.

FIG. 1 shows an exemplary embodiment of a reconfigurable data processing unit. A reconfigurable data processing unit may be, for example, an FPGA (e.g., XILINX Virtex, ALTERA), a reconfigurable processor (e.g., PACT XPP, AMBRIC, MATHSTAR, STRETCH), or a processor (e.g., STRETCHPROCESSOR, CRADLE, CLEARSPEED, INTEL, AMID, ARM), or constructed on its basis or connected to it. Reconfigurable, preferably coarsely granular and/or mixed coarse/fine granular data processing cells (0101), may be arranged in a 2- or multidimensional array (0103). Furthermore, memory cells (0102) may be present in the array, in an exemplary embodiment, on the edges. Each cell individually, or also groups of cells, may preferably be configured in their function for the run time. It may be advantageous if the configuration and/or reconfiguration for the runtime takes place without influencing cells that are not to be reconfigured.

The cells may be connected to each other via a network (0104) which may also be freely configured and/or reconfigured for the runtime in its connecting structure and/or topology. It may be advantageous if the configuration and/or reconfiguration for the runtime takes place without influencing network segments that are not to be reconfigured. The reconfigurable processor may exchange data and/or addresses with the periphery and/or memory by means of IO units (0105) that may comprise address generators, FIFOs, caches and the like.

FIG. 2 shows an exemplary embodiment of a reconfigurable cell that may be implemented, for example, as a coarse granular data processing cell (0101), memory cell (0102), or logic processing cell (e.g., LUT-based CLB, as used in FPGA technology). The cell may have connections to the network (0104) in such a manner that a unit for tapping operands (0104a) and a unit for sending the result to the network (0104b) are provided. The cells may be cascaded horizontally and/or vertically so that the bus sending device (0104b) of a cell on top sends to the bus of the bus tapping unit (0104a) of a cell underneath it.

A unit may be present in the core (0201) of the cell, which unit may be differently designed, depending on the cell function, e.g., as a coarse granular arithmetic unit, a memory, a logic unit (FPGA) or as a permanently implemented ASIC. In the context of the present specification, a 16-bit wide coarse granular DSP- and/or processor-like arithmetic unit (ALU) is typically concerned in the following.

A control unit (0204) may preferably be associated at least with the core (0201), which control unit controls the course of the data processing (0205), processes status information (TRIGGERs) such as, e.g., transfer (CARRY), sign (NEGATIVE), comparison values (ZERO, GREATER, LESS, EQUAL), forwards them to the core for computation (0205), and/or receives them from the latter (0205). The control unit (0204) may tap TRIGGERs from the network and/or send them to the network.

In an exemplary embodiment, units may be provided parallel to the core (0201) for the transmission of data from the upper network onto the network underneath it (0202) or in the inverse direction (0203), preferably laterally. Even a data processing arrangement may preferably be located in the preferably lateral units (0202 and/or 0203) in addition to a data forwarding arrangement, which data processing arrangement makes possible, e.g., calculating operations (ALU operations such as addition, subtraction, shifting) and/or data linking operations such as multiplexes, demultiplexing, merging, swapping, sorting of the data streams transmitted by the units. Both units may preferably be designed in such a manner that they make possible, in addition to their DATA processing functions, the forwarding of TRIGGERS as well as their processing, for example, by means of lookup tables (LUTs) similar to FPGAs.

In the following, the core with its ssociated network connections is also designated as CORE. The lateral units with their associated network connections may also be designated as FREG in data transmission from above downward and as BREG in data transmission from below upward.

A cell consisting of CORE, FREG and BREG is designated as PAE (Processing Array Element). If the CORE has, for example, an arithmetic unit (ALU), it is an ALU-PAE. If memory (RAM) is implemented in the CORE, it is a RAM-PAE. Any further CORE implementations are possible, such as FPGA-like logic processing units (Logic Processing=LP), e.g., in LP-PAEs.

The network may preferably be designed for the synchronization of the exchange of DATA and/or TRIGGERS with a synchronization arrangement, e.g., handshake lines, trigger signal transmissions, and preferably maskable trigger vector signal transmissions, etc. (e.g., a RDY/ACK protocol of the applicant).

Reconfigurable cells in accordance with the state of the art may either be designed for processing individual signals (bits) like FPGA as lookup tables (LUTs) and/or have coarse granular arithmetic units that typically calculate whole-number values (fixed-point numbers) whose width is typically in a range of 4 to 48 bits. The complex calculation of floating decimal point numbers might not be supported by these cells but may be calculated by the configured coupling of a plurality of cells. However, the configured coupling of cells may be extremely inefficient since a great number of cells may be required and much data must be transmitted over the network. This may lead to a rise of current consumption and to a distinctly reduced performance in the calculation of floating decimal point numbers due to the inefficient coupling of many cells.

An implementation of floating decimal point arithmetic into the individual cells also might not be appropriate since the arithmetic may require a large number of hardware resources and in addition floating decimal point numbers may be wider (single precision=32 bits, double precision=64 bits) than typical fixed decimal point values (e.g., 16 bits). Therefore, the bus systems may have to be adapted to the width of the floating-point numbers, which, however, may prove to be extremely inefficient in the typically rather frequent calculation of floating decimal point numbers. Even if a reconfigurable data processing apparatus is primarily used for calculating floating decimal point numbers, it may still be inefficient to enlarge the bus systems for the width of double-precision floating-point numbers since usually single-precision numbers are used in applications. An arrangement is described in the following that, among other things, makes possible a more efficient utilization of the bus systems. It should be noted that, although the description builds on the granularity of PAEs optimized for fixed point numbers, the present invention may also be used for PAEs optimized for single-precision numbers, in particular when the individual PAE is designed at the same time for the SIMD-like calculation of several fixed decimal point numbers.

The present invention describes the implementation of an optimized floating decimal point processing that may be efficient in resources and in performance.

### BRIEF DESCRIPTION OF THE DRAWINGS

FIG. 1 shows an exemplary embodiment of a reconfigurable data processing unit.

FIG. 2 shows an exemplary embodiment of a reconfigurable cell.

FIG. 3 shows an exemplary embodiment in accordance with the present invention.

FIG. 4a shows another view of the exemplary embodiment shown in FIG. 3.

FIG. 4b shows an exemplary mapping of the floating decimal point data formats on the fixed point formats of the ALU-PAEs.

FIG. 4c shows an exemplary embodiment of the linking of different error states (events) in a floating decimal point arithmetic unit.

FIG. 5 shows an exemplary embodiment of an architecture, in which the 16-bit XPP-III architecture of the applicant was expanded to 32 bits with MID capability.

FIG. 6 shows an exemplary embodiment of a BPU in accordance with the present invention.

FIG. 7 shows an exemplary embodiment of integration of the BPU in accordance with the present invention according to FIG. 6 into the VPU architecture of the applicant.

### DETAILED DESCRIPTION

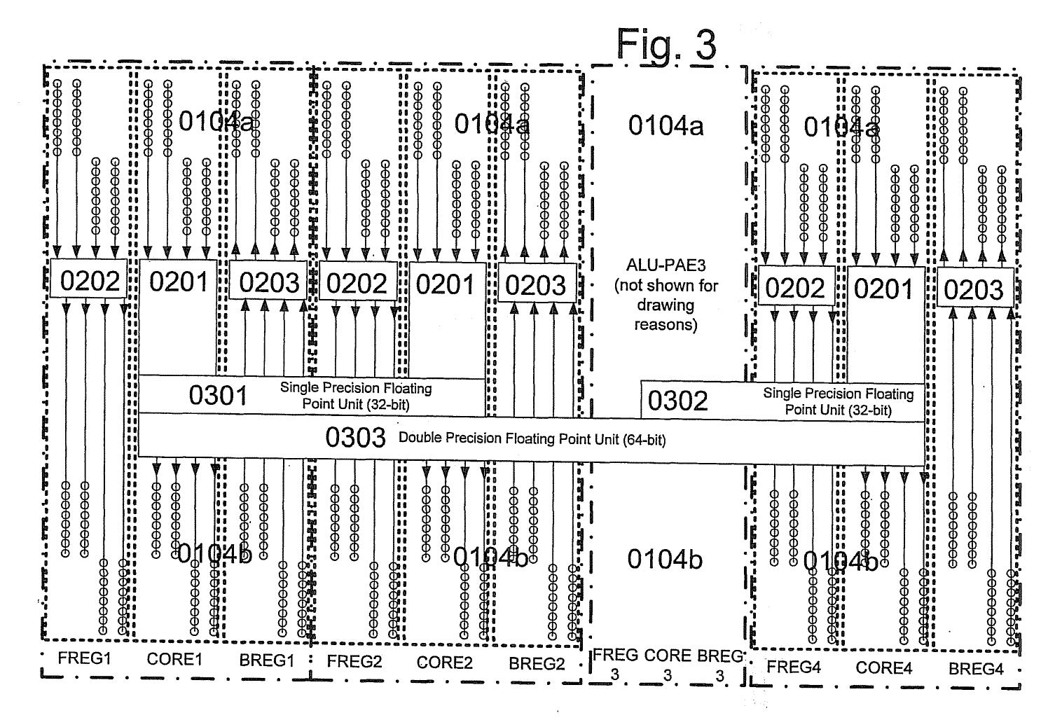

FIG. 3 shows an exemplary embodiment in accordance with the present invention, which is composed here of the 4 ALU-PAEs (ALU-PAE1, . . . , ALU-PAE4), where each ALU-PAE is constructed for its part from FREG, BREG, and CORE ({FREG1, BREG1, CORE1}, {FREG2, BREG2, CORE2}, . . . ). In this exemplary embodiment, the individual data words are 16 bits wide, consequently 16-bit busses are involved and the operands and results of the FREGs, BREGs and COREs are 16 bit or multiplication results 32 bit. (It is not taken into consideration here for the purposes of the present disclosure that the data bus is wider than the data words can be in order, for example, to also be able to transmit synchronization signals and information and trigger signals and information, etc. The fact that, for the rest, a separate synchronization network or lines and/or trigger network or lines may be provided and/or a circuit arrangement for the construction, e.g., reconfigurable construction of the same, is mentioned). Let w be the width of a floating decimal point (for example, 16 bits) that can be calculated in an ALU-PAE. Let p be the width of a floating decimal unit to be implemented (e.g., p=32 for single precision, p=64 for double precision).

ALU-PAEs may typically have at least two operand inputs A and B. However, the width of the inputs typically does not necessarily correspond to the width of the calculatable floating decimal point numbers.

Several ALU-PAEs may be combined in such a manner to a new hierarchy (box) that the sum of the width of their A_{fix}, and B_{fix} operand inputs corresponds to the required width of an operand A_{float} and B_{float} of the floating decimal point unit. In other words, the following is true:

n=width(A_{float})/width(Aᵢₙₜ), and thus, width(A_{float})=Σwidth(Aᵢₙₜ[0..n]), and n=p/w, and thus, p=Σw[0..n].

Now, a floating decimal point arithmetic unit with the width A_{float}=p may be implemented in the new hierarchy (box). This may provide the following advantages:

1. The resources of a floating decimal point arithmetic unit may be distributed over n fixed decimal point arithmetic units (ALU-PAEs). Since in typical applications fewer floating decimal point operations are required than fixed decimal point operations, this may result in an extremely ideal ratio with optimal resource usage.
2. The fixed point number network implemented for the use of the fixed decimal point units (ALU-PAEs) may be used unchanged for floating decimal point numbers in that several of the fixed decimal point network connections are bundled to a floating decimal point connection.

FIG. 3 shows an exemplary embodiment in accordance with the present invention consisting of 4 ALU-PAEs (ALU-PAE1={FREG1, CORE1, BREG1}, ALU-PAE2={FREG2, CORE2, BREG2}, . . . ). In a first box (DOUBLE1) consisting of the two ALU-PAEs ALU-PAE1 and ALU-PAE2 a single precision floating decimal point arithmetic unit (0301) may be additionally implemented. This additional floating decimal point arithmetic unit is not present in traditional array elements. It is also not composed by pure configuration from circuits that are present in any case, but rather only circuit elements already present for the operation of the additional floating decimal point arithmetic unit arrangement may be used, which, however, could not have been used alone, that is, without the dedicated additional hardware of the floating decimal point arithmetic unit, in any case not as well for floating decimal point operations.

(0401) may use the inputs of the ALU-PAE1 and ALU-PAE2 as operand input and the outputs of the two ALUs as result output. The floating decimal point number format (in this example 32 bit) may be transmitted via several (in this example 2) combined floating decimal point busses (in this example 16 bit).

In a second box (DOUBLE2) the ALU-PAEs ALU-PAE3 and ALU-PAE4 may be combined—as described for DOUBLE1 —to a further single precision floating decimal point arithmetic unit (0302), i.e., provided with a further additional floating decimal point arithmetic unit.

Furthermore, a third box (QUAD) may be formed that consists of the boxes DOUBLE1 and DOUBLE2. This box may now consist of 4 ALU-PAEs and has (in this example) 4×16 bit=64-bit inputs for the operands A and B and correspondingly as many outputs for the results. The width of the operand inputs and result outputs may now be sufficient for implementing a 64-bit double precision floating decimal point arithmetic unit inside the QUAD. To this end a further additional floating decimal point arithmetic unit now designed as a double precision arithmetic unit may be provided in addition to the two single precision arithmetic units already additionally provided as hardware in the boxes in accordance with the present invention in the exemplary embodiment described. Note that a nesting may not be obligatory. If it was known in advance that only and exclusively double precision arithmetic units are required, even the providing of the two single precision arithmetic units in the individual boxes may be eliminated if necessary and a double precision arithmetic unit may be directly and exclusively provided. The opposite may also be applicable. Also, fixed forms may be possible within a cell field. It may be preferable, among other things, if line-by-line and/or column-by-column floating point (i.e., floating decimal point) arithmetic units are provided.

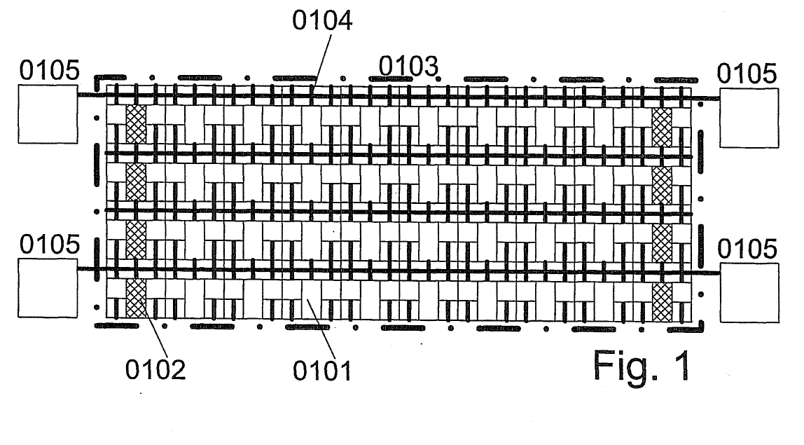

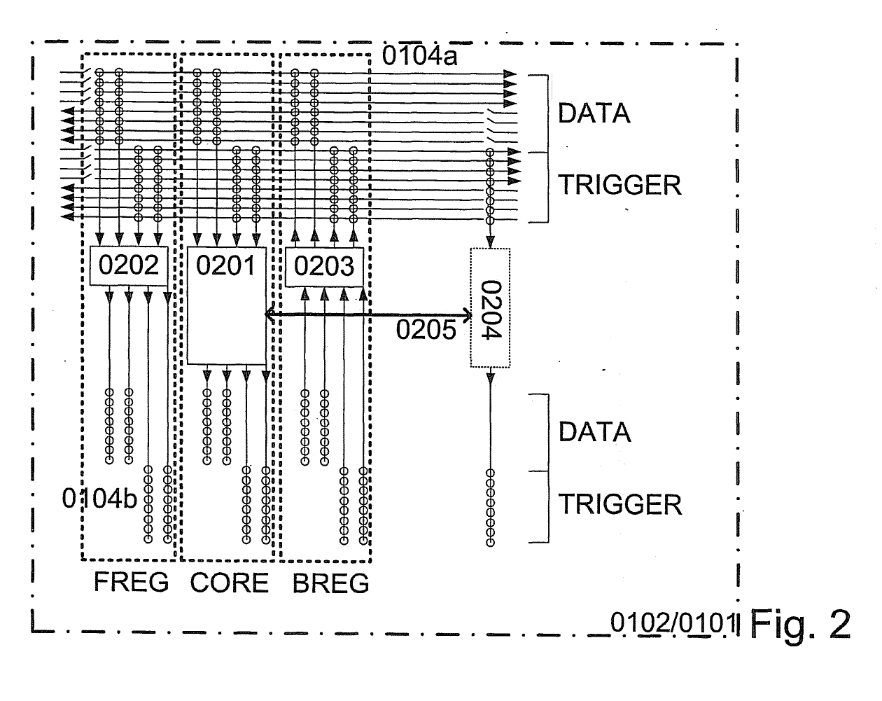

FIG. 3 shows only a section of a reconfigurable data processing unit according to FIG. 1. The structure shown here may be scaled over the entire data processing unit. Thus, all PAEs of the unit may be appropriately combined to boxes. On the other hand, insofar as less floating decimal point performance may be required in the application, even only a part or parts of a data processing unit may comprise the floating decimal point structure in accordance with the present invention, which then preferably takes place column-by-column, i.e., PAEs are appropriately combined column-by-column.

State machines do not necessarily have to be associated with the floating decimal point arithmetic units but it is possible. However, state machines may be advantageous when iterations such as for root calculations and/or divisions are or may be typically necessary. In such a case the floating decimal point arithmetic units or at least a part of them may preferably have registers or other memory access possibilities, for example, by access to memory elements in the array in which lookup tables for (trigonometric and/or other) functions may be filed and, namely, configured and/or permanently integrated. Above all, but not only when iterations and/or other, such as sequence-like usages, of a floating decimal point arithmetic unit are provided, it may be furthermore and/or additionally advantageous to provide a feedback of the operand outputs to the operand inputs. It should be mentioned that even feedbacks for status signals are optionally possible.

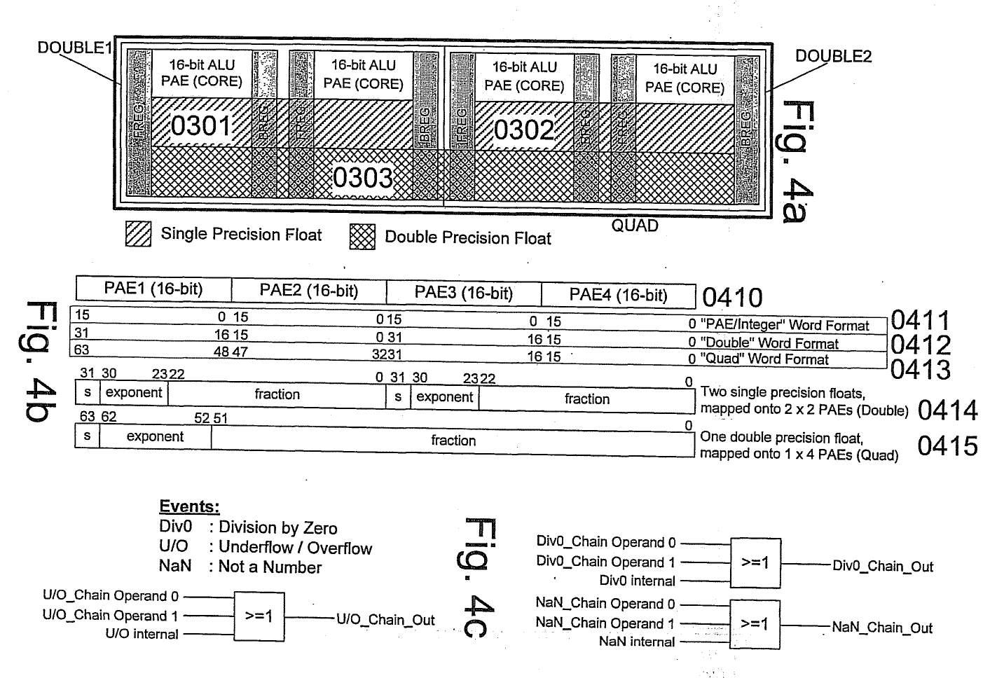

For a better survey, FIG. 4a again shows the exemplary embodiment shown in FIG. 3, as well as the DOUBLE and QUAD boxes.

FIG. 4b shows an exemplary mapping of the floating decimal point data formats on the fixed point formats of the ALU-PAEs. 4 ALU-PAEs (0401) and their word format of four times 16-bit (0411), Among them (0411) the word width of two 32-bit floating decimal point numbers is shown and among them (0412) the word width of a 32-bit floating decimal point number. (0414) shows the mapping of two 32-bit single precision floating decimal point numbers and (0415) the corresponding mapping for a 64-bit double precision floating decimal point number. s designates the sign (Sign).

The handling of error signals such as, e.g., overflow, underflow, division by zero and erroneous number representation (Not a Number=NaN), constitutes a significant problem. In processors that typically have only a floating decimal point arithmetic unit an interrupt is typically initiated in order to indicate the occurrence of an error. In a data flow architecture in which a plurality of floating decimal point arithmetic units may be interconnected in any arrangement, topology and series by the network, the initiation of an interrupt or the determination of the error source may not be readily carried out.

The following processes and structures may be used in accordance with the present invention as a function of the area of use. In particular, not all of these variants indicated in the following must be implemented, even if this may apparently be advantageous.

A) The error displays of all floating decimal point arithmetic units may be sent to a network that indicates the occurrence of an error to a higher-order unit. This may take place by initiating an interrupt in a higher-order unit that further processes the result. Each floating decimal point arithmetic unit may store the error state that occurred, thus, e.g., overflow, underflow, division by zero and erroneous number representation (Not a Number=NaN). This memory may be queried by a higher-ordered unit that further processes the result, typically at any time but may preferably be queried in response to a recognition of an error. Note that instead of a passive indication of relevant errors in formations for the query, an active transmission to relevant positions may also take place instead and/or additionally. The query may take place, e.g., by JTAG, in particular, a debugger software running on the higher-order or external unit may query the error states.
B) An alternative process may be the sending of error signals (e.g., overflow, underflow, division by zero and erroneous number representation (Not a Number=NaN) to the TRIGGER network within the reconfigurable data processing unit. The TRIGGER network may forward the error signals to the floating decimal point arithmetic units that subsequently process the data which units OR the incoming error signals, e.g., with errors occurring in their own arithmetic unit and then may forward them back to the TRIGGER network together with the data. Thus, in this process an error recognition may also be transmitted to the TRIGGER network with—preferably each—floating decimal point data word transmitted on the DATA network. This does not have to be realized for all network connections but it may be sufficient as a function of the application if this forwarding takes place on at least a few of the data circuits. Then, an error state may be emitted with (preferably) each generated calculated result of the reconfigurable data processing unit which error state indicates the correctness or erroneousness of the result. Now, upon the occurrence of an erroneous result, an interrupt may also be generated in a higher-order unit further processing the result and/or the error state of the result may be queried by a higher-order unit further processing the result.

As in process A) each floating decimal point and arithmetic unit may store the error state that occurred, thus, e.g., overflow, underflow, division by zero and erroneous number representation (Not a Number=NaN). This memory may be queried by a higher-order unit at any time but preferably in the reaction to the occurrence of a result characterized as erroneous. This may take place, e.g., by JTAG, and in particular a debugger software running on the higher-order or external unit may query the error states.

FIG. 4c shows an exemplary embodiment of the linking of different error states (events) in a floating decimal point arithmetic unit. Internally occurring errors may be linked with the particular incoming error signals of the particular operands (e.g., A and B) and forwarded with the result.

Depending on the area of use of the architecture, instead of the implementing of two single precision and/or one double precision floating decimal point arithmetic unit per QUAD, the implementing of one or more SIMD floating decimal point arithmetic units may be advantageous in order to calculate a double or multiple precision floating decimal point number or two single (or, e.g., multiple halves) floating decimal point numbers per SIMD. In this regard, the publication “A New Architecture For Multiple-Precision Floating-Point Multiply-Add Fused Unit Design”, Libo Huang, Li Shen, Kaui Dai, Zhiying Wang, School of Computer, National University of Defense Technology, Changsha, 410073, P.R. China, is incorporated to its full extent for purposes of disclosure. As regards the functional scope of the floating decimal point arithmetic units, it may be sufficient if they are designed for multiplication, addition and subtraction, preferably also for root formation and division, which, however, is not intended to exclude the implementation of further functions in more complex arithmetic units and which for the rest should not exclude the implementation of further, e.g., comparative functions such as greater, smaller, equal, greater than zero, smaller than zero, equal to zero etc. as well as in particular also format conversion functions, e.g., double precision in integer.

Furthermore, it may be advantageous in areas of use, instead of combining several PAEs to a DOUBLE, to increase the processing width within a PAE and therewith also its bus width and to design the floating decimal point arithmetic units within a PAE as SIMD arithmetic units in such a manner that either a calculation of full width or several calculations with lesser width can be carried out at the same time, for example, a 32-bit calculation, or two 16-bit calculations, or one 16-bit and two 8-bit calculations at the same time, or four 8-bit calculations at the same time, etc.

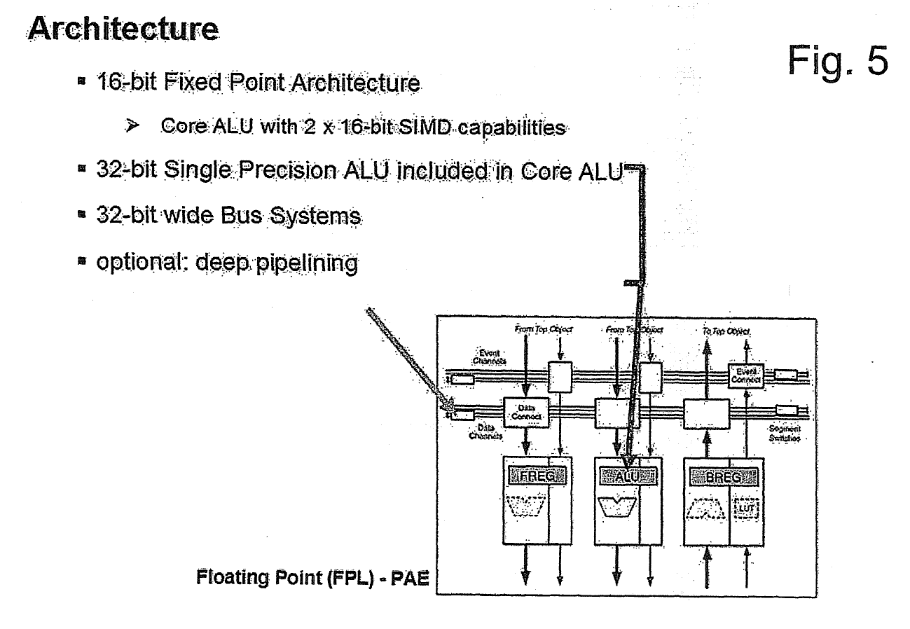

FIG. 5 shows an exemplary embodiment of an architecture, in which the 16-bit XPP-III architecture of the applicant was expanded to 32 bits with SIMD capability, with which each ALU-PAE may thus also carry out a single precision floating decimal point calculation.

Furthermore, ALU-PAEs may also be combined in this process in order to make possible a greater processing width, e.g., a 64-bit double precision DOUBLE (previously QUAD) may be formed with two 32-bit SIMD/single precision ALU-PAEs.

The floating decimal point arithmetic units may preferably have one or more internal register stages, so-called pipeline stages, that make the operation of the arithmetic units possible at high frequencies. This may be in particular a great advantage in data flow architectures such as in the PACT XPP technology of the applicant, since these architectures may typically have no or only few pipeline stalls. Furthermore, the processor model may largely avoid loops in a configuration, so that no feedback effects occur that may have a negative effect on the performance when using pipelines. Note in particular in this connection, the patent applications of the applicant concerning compilers, which are incorporated to their full extent for purposes of disclosure.

In the exemplary embodiment presented above, the bus- and line structures required per se in any case may be provided on an integrated array circuit, preferably on the output of boxes, preferably of each box multiplexer, with which output signals from the traditional arithmetic units, that is, the fixed decimal point arithmetic units and the floating decimal point arithmetic units may be connected alternatively to a bus or to another output element such as a memory, an I/O port and the like. This multiplexer may either be fed in a preferred embodiment from the integer arithmetic units in an individual cell, the single precision floating decimal point arithmetic unit of a box combining two individual cells or in the double-precision arithmetic unit of a double box. Note that in addition to data, corresponding trigger signals and/or synchronization signals and/or control signals may also be multiplexed here.

Another aspect of the present invention relates to an efficient unit for processing Boolean operations (BPU Bit Processing Unit). For example, the following calculations may be significant for the unit in applications:

Implementation of state machines,
Implementation of decoders and encoders,
Performing permutations at the bit level as required, e.g., for DES/3DES, and
Implementation of serial bit arithmetic such as, e.g., pseudo-noise generators.

Coarsely granular arithmetic units such as ALUs may be poorly suited for the applications cited by way of example since very many calculating steps are necessary for calculating a single bit and at the same time frequently only a few bits, in the typical case even only one bit, may actually be used from a broad data word (e.g., 16-bit).

FPGA technologies according to the state of the art (e.g., XILINX, ALTERA) may be capable of carrying out all functions cited by way of example but are comparatively inefficient as regards the necessary surface, the number of configuration bits and the current consumption.

The design of the BPU in accordance with the present invention may be less able to be used as desired for logic networks but rather may be specialized for the following functionality:

1. Construction of state machines,
2. Construction of counters and sliders,
3. Construction of bit permutators (e.g., for DES),
4. Construction of conditioned multiplexers, and
5. Construction of tight and efficient bit-serial operations (e.g., for pseudo-noise generators).

An aspect of the present invention may reside in the implementation of hardware elements for carrying out tight and efficient bit-serial operations.

A further aspect of the present invention may be viewed in particular in directly supporting multiplexers in hardware that are conditioned at the start. In addition to ensuring any multiplex functionality at the bit level, e.g., for any bit permutations, extractions or combinations, any desired combinational network may be built up on multiplexers. Hardware design languages (HDLs) such as Verilog or VHDL may be based essentially on the usage of conditioned multiplex operations that may then be transferred by synthesis tools into gate network lists.

The architecture described in the following may make possible a simpler and more rapid imaging of HDL constructs. In the meantime, synthesis tools for FPGA architectures in accordance with the state of the art may have run times of several hours to days, so that a more rapid imaging ability may be considerably advantageous.

In particular, the HDL may also be described in a more optimal manner by the programmer since he may have a simple and basic understanding for the hardware underneath it and may therefore optimize his code, the arithmetic/architecture and implementation in a considerably better manner. Synthesis tools in accordance with the state of the art may usually offer rather good automatic optimization techniques that, however, frequently fail at critical and relevant code positions; however, at the same time the synthesis tools take every possibility of direct influence on the hardware, so that an optimal implementation may frequently be hardly possible.

The conditioned multiplexer is a typical construct in HDLs and may form at the same time the essential model for expressing complex logic:

var1=if(bool_{—}func1)?(bool_{—}func2):(bool_{—}func3).

If the Boolean function bool_func1 is true, the Boolean function bool_func2 is assigned to the variable var1, otherwise bool_func3.

According to the present invention, logic processing units may now have a comparator that evaluates the logical truth and the logical value of bool_func1. This may preferably take place via a customary rapid comparator, e.g., built up from linked XOR gates. The evaluation result (TRUE/FALSE <=>1/0) may be forwarded to one or more multiplexers that send bool_func2 (if TRUE=1) or bool_func3 (if FALSE=0) to the output as a function of the result. The multiplexers may be 1 bit wide or several bits wide, and the hardware implementation may preferably allow an optimized mixture.

It may be furthermore preferred that the hardware implementation provides an arrangement for making simple logical links (Boolean functions) possible in front of the multiplexer. For example, a 2-fold lookup table may be implemented in front of each multiplexer input, which table may make possible any desired Boolean linking of two input signals or the direct forwarding of only one of the signals.

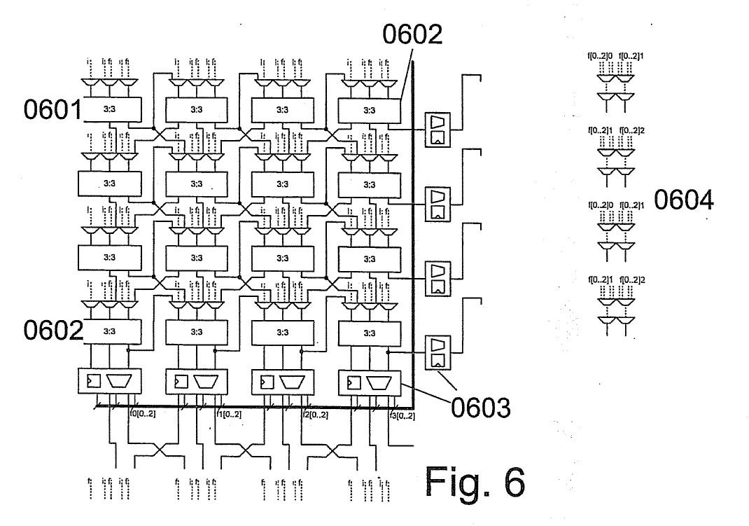

FIG. 6 shows an exemplary embodiment of a BPU in accordance with the present invention. It shows a 4×4 section of a configurable logic field (Field Programmable Gate Array, FPGA). Each gate may be based on a 3-input to 3-output LookUp Table (LUT, 0601) that calculates an independent lookup function for each of the three outputs on the basis of all 3 inputs. In contrast to FPGAs in accordance with the state of the art, the individual cells may have no register function, but rather, registers on the edges (in this exemplary embodiment on the south edge and east edge) are associated with an amount of cells (in this exemplary embodiment with a 4×4 matrix). A register (0603) may be associated in a configurable manner with each output of the LUTs edges (0602), which register may either be switched on in order to forward the output signal in a register-delayed manner or may be bypassed by a multiplexer function, which corresponds to a non-delayed forwarding of the output signal.

The LUTs may receive the input signals from a higher-order bus system in a configurable manner via multiplexers (0604). Furthermore, a feedback of the register values (f[0..2] [0..2) onto the LUT inputs may be possible, also in a configurable manner via the multiplexers (0604).

The 4×4 matrix shown may be freely cascaded, as a result of which large configurable logic fields may be built up.

An aspect of the BPU in accordance with the present invention may be the improved prediction of the timing and a protection from so-called undelayed feedback loops, that can result on account of an asynchronous feedback in the physical destruction of the circuit. To this end the following rule may be implemented: data is conducted through the logic field only in one of the compass bearings North-South and one of the compass bearings East-West.

In the exemplary embodiment shown in FIG. 6 the running direction of the main signal may be in a column from north to south and for carries signals may be transmitted in a series from west to east. A diagonal signal transmission is also possible in a north-south direction.

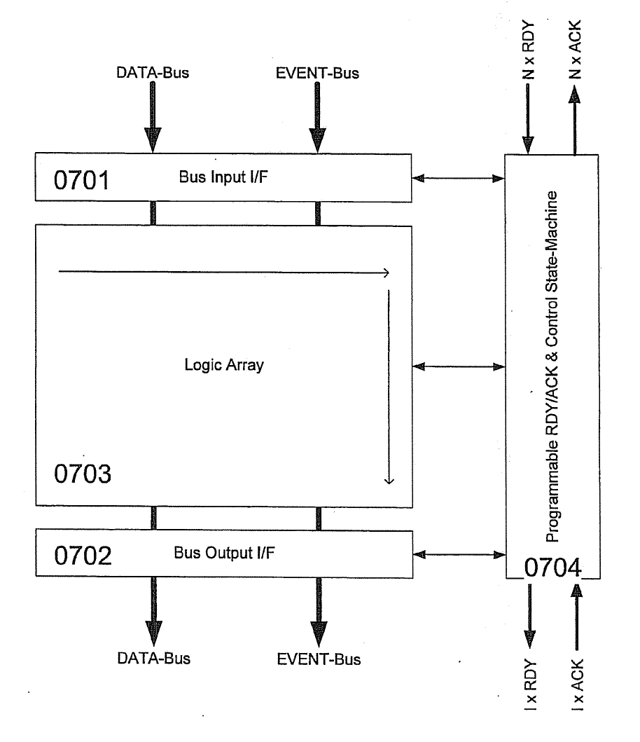

FIG. 7 shows an exemplary embodiment of integration of the BPU in accordance with the present invention according to FIG. 6 into the VPU architecture of the applican and/or its assignee(s). To this end, all existing patent applications of the applicant and/or its assignee(s) are incorporated to their full extent for purposes of disclosure. The circuit may have a bus input interface (0701) that receives data and/or triggers from a configurable bus system. A bus output interface (0702) may switch the signals generated by the one logic field (0703) onto data- and/or trigger buses. Logic field (0703) may comprise a multiplicity of BPUs according to FIG. 6 arranged in a tiled multidirectional manner. The arrows illustrate the running directions of the signals inside the logic array, corresponding to the description in FIG. 6.

A freely programmable state machine (0704) may be freely associated with the bus interfaces in the logic field, which state machine assumes the control of the course of the bus transfer and/or generation of controls and/or synchronization tasks.

As is known from, among other things, U.S. patent application Ser. No. 10/156,397 and U.S. Pat. No. 7,036,036, the VPU technology may have handshake protocols for the automatic synchronization of data- and/or trigger transmissions. When using the BPU of the present invention in the VPU technology, the state machine (0704) additionally and in particular may manage the handshakes (RDY/ACK) of the bus protocols of the input- and/or output bus.

The signals from the bus input interface (0701) and/or bus output interface (0702) may be routed to the state machine for control, which latter may generate control signals for controlling the data transmissions for the appropriate interface. Furthermore, the state machine may receive signals from the logic field (0703) in order to be able to react to its internal states. Inversely, the state machine may transmit control signals to the logic field.

The state machine may preferably be programmable in a broad range in order to ensure maximal flexibility for the use of the logic field. However, functionally critically parts of the state machine may preferably be permanently implemented such as, e.g., the handshake protocols of the busses. This ensures that the base functionality of a BPU may be ensured at the system level. All bus transfers may be executed correctly on the system level by definition through the permanently implemented part of the state machine. This may facilitate the programming and the debugging on the system level.

The freely programmable part, in which the programmer may implement the control of the logic field as a function of the particular application, may be associated with this permanently implemented part of the state machine (0704).

1. (canceled)

2. A reconfigurable data processing unit, comprising:
a plurality of coarsely granular fixed point arithmetic units combined into blocks, each block forming a floating decimal point unit.
